(19) United States
(12) Patent Application Publication
(10) Pub. No.: US 2008/0168829 A1
(43) Pub. Date: Jul. 17, 2008

(54) Diaper soil wetness strip

(76) Inventor: Robert Paez, Covina, CA (US)

Correspondence Address: CHRISTIE, PARKER & HALE, LLP, PO BOX 7068, PASADENA, CA, 91109-7068, US

(21) Appl. No.: 11/653,620

(22) Filed: Jan. 12, 2007

(51) Int. Cl. G01N 5/02

(52) U.S. Cl. 73/73

(57) ABSTRACT

A wetness indicator is provided for use with diapers or other protective clothing. The wetness indicator gives an external indication of wetness generated by the wearer of diapers or other protective clothing to facilitate prompt changing of the diaper or other protective clothing when needed.

The present invention is directed to a wetness indicator or strip, particularly for use with a diaper or other form of protective clothing.

### BACKGROUND OF THE INVENTION

Diapers and other forms of protective clothing are used on infants and the elderly suffering from incontinence to protect outer clothing and the surroundings from being exposed to urine or feces when the infant or elderly person wets or soils themselves. While present diapers and other forms of protective clothing do a good job containing such material, they do not prevent the wearer's skin from exposure, which can lead to discomfort and rashes, particularly if the exposure continues for a long period of time. Yet, the better the job of containment, the less noticeable it is from the outside that the infant or elderly person has wet or soiled themselves.

In a situation where an infant or elderly person is not able to clearly communicate their situation, exposure to urine and/or feces may persist for longer than is desirable. Moreover, children may well cry or act up if they are uncomfortable and a parent may not immediately realize that a wet or soiled diaper is the cause. In addition, checking to see if that is the problem may defeat the containment performance of the diaper and lead to leakage and/or odor problems. Moreover, even if a child does not cry or act up, a parent will want to know if a child has wet or soiled themselves before it becomes apparent to others in social settings, such as at a park or playground.

Accordingly, a need exists for a way to more quickly and reliably indicate when an infant or elderly person has wet and/or soiled their diaper or other form of protective clothing.

### SUMMARY OF THE INVENTION

The present invention, in various embodiments, provides an indicator strip that will let parents or caretakers know when an infant or elderly person has wet and/or soiled their diaper or other form of protective clothing. One end or portion of the strip is positioned inside the protective clothing where it will be exposed to potential wetness. Another end or portion of the strip is positioned outside the protective clothing, where an indication of wetness at the inside end is conveyed. The indication of wetness may, in one embodiment, be conveyed by a color change at at least the outside end. Any number of colors and color changes may be adopted. The outside end of the strip may also be designed to be in various different shapes, such as simple geometric shapes or the shape of a favorite cartoon character. It may also be decorated in a variety of ways. A fragrance component may also be included to combat any odor associated with the strip. An adhesive backing may also be placed on the outside end or tab so that it can be applied to the external surface of outer clothing.

### BRIEF DESCRIPTION OF THE DRAWINGS

FIG. 1 shows a schematic top view of an indicator strip in accordance with one embodiment of the present invention.

FIG. 2 shows a schematic side view of the indicator strip of FIG. 1

FIG. 3 shows a pictorial view of one embodiment of an indicator strip in accordance with the present invention in place on an infant.

### DETAILED DESCRIPTION OF THE INVENTION

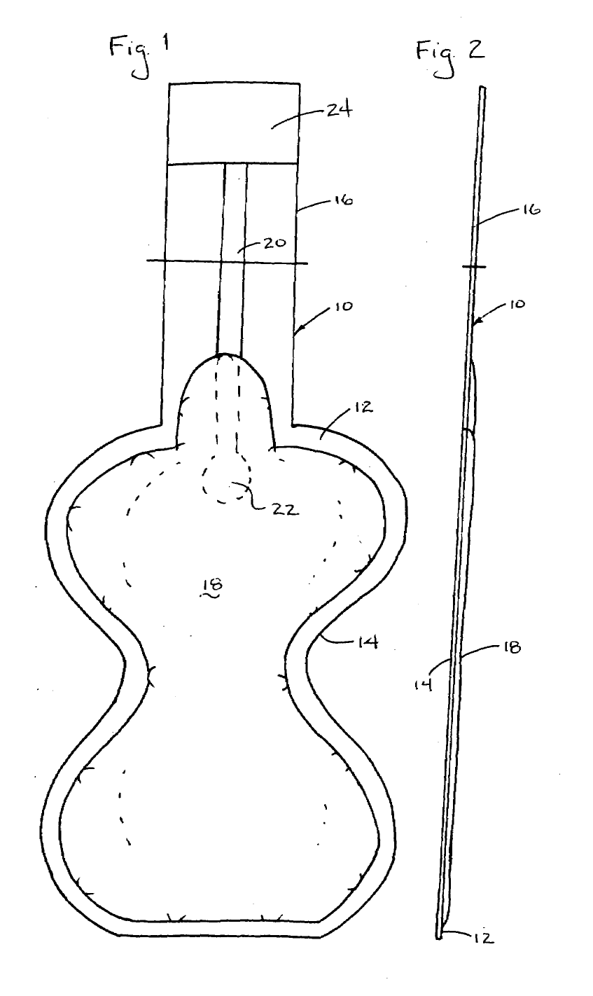

With reference to FIG. 1, an exemplary embodiment of the present invention is shown. An indicator 10 has a backing or support piece 12 that in this particular embodiment has a body portion 14 and an elongated neck portion 16 extending from the body portion. The overall shape of the backing is a flat sheet (see FIG. 2) with a border configured generally like that of a guitar or a long-necked bottle. The backing is preferably made of a flexible, water resistant material, such as a plastic like polyethylene.

Body portion 14 is designed to fit between the legs of a wearer inside a diaper or other protective garment. In use, the backing will be held away from the wearer by an absorbent pad 18 attached to the inner surface of the backing. Pad 18 is positioned so as to receive wetness or moisture generated by the wearer. Backing 12 should be sufficiently flexible to be able to conform to the shape of the wearer and be worn comfortably. Because it is water resistant, or even water proof, the backing will help hold any wetness or moisture picked up by the pad inside the pad. The pad may be made of cotton or any other absorbent material appropriate for use next to a wearer's skin.

The indicator also has a conduit 20 attached to or otherwise incorporated into neck portion 14. At one end the conduit has a receptor 22 within pad 18. From that receptor, the conduit extends up the length of the neck portion to an indicator tab 24. In use, receptor 22 is designed to detect wetness or moisture in the pad and then convey or otherwise transmit that information to the indicator tab, where the indicator tab will then provide some indication, such as through a visual or audible signal, that wetness or moisture has been detected.

Detection of wetness or moisture, the transmission of that information, and the indication of that information may each be accomplished in a variety of ways. For example, the receptor could pick up wetness or moisture and convey it through a wicking or capillary action to the tab where it comes in contact with a chemical indicator that will change color when exposed to urine and/or other liquids. In such an embodiment, conduit 20 would be a capillary tube, preferably made of plastic, or a wicking material. Alternatively, the receptor could be an electrical switch that is activated in the presence of wetness or moisture, and the conduit would then be a conductive material, such as a wire, that would convey an electrical signal to the indicator. In such an alternative embodiment, the indicator could be a lamp that would light up when the switch was triggered.

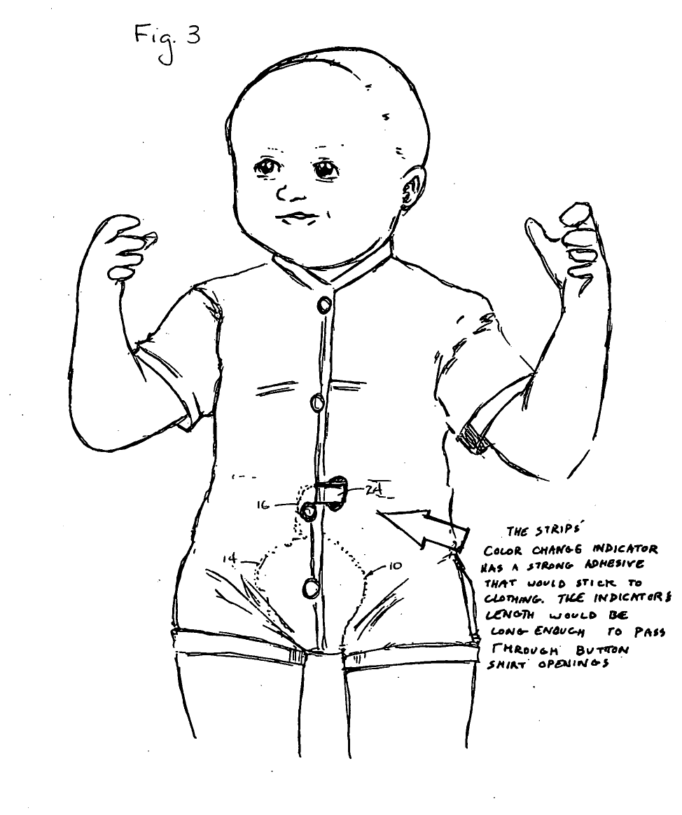

The length and configuration of neck portion 16 is preferably such that it allows the indicator tab to be located in an externally visible location when the indicator is being worn. FIG. 3 shows an embodiment where the indicator tab is able to extend up from the body portion and be placed outside the wearer's clothing. In this embodiment, the tab also has an adhesive back to allow the tab to be positioned on the outside of a wearer's clothing. The adhesive is preferably initially covered by a release lining to prevent the tab from sticking to anything before it is in its desired position. The release liner could then be removed to attach the tab.

The tab can be designed to be in various shapes and sizes, so as to be attractively incorporated with other clothing being worn. With infants, it could be in an interesting geometric shape or that of a favorite cartoon character. For an elderly person, it could be in a shape and color as to make it inconspicuous until such time as it is providing a wetness indication. Fragrance may also be incorporated into the indicator and/or the tab to help mask any odor associated with use of the indicator.

The indicator embodiments shown in the various figures are a stand alone product that can be used with a variety of preexisting diapers and/or other protective clothing. However, it should be understood that the indicator could be incorporated into a diaper or other form of protective clothing. In such an embodiment, the place of the body portion of the backing may be taken by the diaper or protective garment itself. Moreover, other variations and modifications may also be made that would be understood by one of ordinary skill in the art as being within the scope of the present invention. Thus, the described embodiments are merely intended to be illustrative of the present invention, the full scope of which is set forth in the following claims.

What is claimed is:

1. An indicator for use with protective clothing comprising:
a receptor positioned to be able to detect wetness generated by a wearer; and
a conduit adapted to convey the detection of wetness to an external indicator device.

2. An indicator in accordance with claim 1 wherein the receptor is one end of a wicking material and the conduit is a length of the wicking material.

3. An indicator in accordance with claim 1 wherein the receptor is an open end of a capillary tube and the conduit is a length of the capillary tube.

4. An indicator in accordance with claim 1 wherein the receptor is an electrical switch that is triggered in the presence of wetness and the conduit is a length of a conductive material extending from the switch.

5. An indicator in accordance with claim 4 wherein the conduit is a wire.

6. An indicator in accordance with claim 1 wherein the indicator device changes color to provide a visual indication of wetness.

7. An indicator in accordance with claim 6 wherein the indicator device is a tab containing a chemical that changes color on exposure to a liquid.

8. An indicator in accordance with claim 7 wherein the chemical changes color on exposure to urine.

9. An indicator in accordance with claim 4 wherein the indicator device is a lamp that lights to provide a visual indication of wetness.

10. An indicator in accordance with claim 1 wherein the indicator device is adapted to be attached to an external surface of clothing worn by the wearer.

11. An indicator in accordance with claim 10 wherein the indicator device is a tab with an adhesive backing.

12. An indicator in accordance with claim 11 wherein the adhesive backing is covered by a removable release liner.

13. Protective clothing for use by a wearer comprising:
a receptor positioned to be able to detect wetness generated by the wearer; and
a conduit adapted to convey the detection of wetness to an external indicator device.

14. Protective clothing in accordance with claim 13 wherein the protective clothing is a diaper.

15. An indicator strip for use with protective clothing comprising:
one portion of the strip adapted to be positioned inside the protective clothing where it will be exposed to wetness generated by a wearer of the protective clothing;
a second portion of the strip adapted to be positioned outside the protective clothing where it can provide a visual indication of wetness generated by a wearer; and
means for conveying the exposure of the one portion of the strip to wetness to the second portion of the strip.

16. An indicator strip in accordance with claim 15 wherein the protective clothing is a diaper.
